(19) United States
(12) Patent Application Publication
(10) Pub. No.: US 2009/0299861 A1
(43) Pub. Date: Dec. 3, 2009

(54) Interactive OnLine Fundraising Promotion

(75) Inventors: Wendi Diann Littlefield, West Hollywood, CA (US); Ari Samuel Mark Brock, Los Angeles, CA (US); Michael Alan Fiore, JR., Van Nuys, CA (US)

Correspondence Address: MORRISON & FOERSTER, LLP, 555 WEST FIFTH STREET, SUITE 3500, LOS ANGELES, CA, 90013-1024, US

(73) Assignee: Starlight Starbright Children's Foundation, Los Angeles, CA (US)

(21) Appl. No.: 12/130,774

(22) Filed: May 30, 2008

(51) Int. Cl. G06Q 30/00; G06F 3/048; G06F 17/30; G06Q 40/00; G06F 15/16

(52) U.S. Cl. 705/14.73; 715/764; 707/104.1; 709/203; 705/35; 707/E17.009

(57) ABSTRACT

Customized interactive fundraising promotion technology operable to provide users with an interactive interface for designing a personalized graphic object is disclosed. In one embodiment, the user can custom design the graphic object for presentation on a webpage interface in return for making a donation. In another embodiment, the user's custom design can be viewed on the Internet by a community.

### FIELD OF THE INVENTION

The present invention relates generally to Internet communication, and more particularly to interactive on-line fundraising via the Internet.

### BACKGROUND OF THE INVENTION

The Internet has been shown to be an effective forum for raising money. Large sums of money have been raised for political races and other purposes. Moreover, there are numerous worthy causes for which to raise money such as, for example, children with chronic pain, cancer, and other serious illnesses. Furthermore, the ubiquity of the Internet makes it possible to reach a large audience for fund raising.

Conventionally, there are few tools to help a person make a donation for a good cause. Existing tools provide interfaces that allow collecting donations via the Internet. Using these tools contributors can make donations from the comfort of their homes and businesses, but few tools available on the Internet allow the contributor “to get something back too.” Using the existing tools, a sponsor may not be able to add personalized sponsorship promotional information (such as their logo) for sharing with a community. Allowing a contributor to promote their brand or share their messages on-line in return for making a donation may be of great motivation for those making donations. Therefore, there is a need for interactive on-line promotional fundraising systems and methods.

### SUMMARY OF THE INVENTION

Embodiments of the present invention are directed to an interactive on-line fundraising promotion technology operable to provide users with means to promote their brand or share their message on-line. The interactive on-line fundraising promotion technology provides a means for allowing a user to design graphical objects for presentation on a webpage in exchange for donating a payment using the webpage. It should be noted that the term “design” or “designing” as used throughout the specification and the claims is additionally inclusive of edit or editing and designate or designating.

A first embodiment of the invention comprises a system for on-line interactive graphic design. The system comprises logic for providing an interactive graphic suitable for presentation on a webpage interface, and providing a plurality of design options to a user on the interactive graphic. The system further comprises logic for allowing the user to design a graphic object for presentation at a location on the interactive graphic, wherein the graphic object is based in part on at least one of the design options. The system also comprises logic for receiving location information from the user, wherein the location information is associated with the location on the interactive graphic, and receiving a donation from the user based in part on the at least one of the design options.

A second embodiment of the invention comprises a method for on-line interactive graphic design. The method comprises allowing a user to design a graphic object for presentation at a location on an interactive graphic, wherein the interactive graphic is suitable for presentation on a webpage interface. The method further comprises receiving location information from a user, wherein the location information is associated with a location on the interactive graphic, and receiving a donation from the user based on the design.

A third embodiment of the invention comprises a computer-readable medium comprising program code for providing an on-line interactive graphic design. The computer-readable medium further comprises program code for allowing a user to design a graphic object for presentation at a location on an interactive graphic, wherein the interactive graphic is suitable for presentation on a webpage interface. The computer-readable medium also comprises program code for receiving location information from a user. The location information is associated with a location on the interactive graphic. Furthermore, the computer-readable medium comprises program code for receiving a donation from the user based on the design.

A fourth embodiment of the invention comprises an interface for creating a customized graphic object. The interface comprises an interactive graphic operable for allowing a user to create a customized graphic object for presentation on a webpage display in relation to a location on the interactive graphic. The interface further comprises a plurality of design selection areas operable for selecting a design option for creating the customized graphic object, and a payment area operable for receiving a donation from the user based on the design option.

Further features and advantages of the invention, as well as the structure and operation of various embodiments of the invention, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a diagram of an exemplary environment of operation according to one or more embodiments of the invention.

FIG. 2 shows an exemplary webpage interface according to an embodiment of the invention.

FIG. 3 illustrates a webpage interface showing a depiction of a part of a universe which includes galaxies of a particular type.

FIG. 4 illustrates an exemplary webpage interface showing a galaxy information bubble according to an embodiment of the invention.

FIG. 5 illustrates an exemplary webpage interface showing stars in a galaxy according to an embodiment of the invention.

FIG. 6 illustrates an exemplary webpage interface showing stars in a galaxy according to an embodiment of the invention.

FIG. 7 illustrates an exemplary webpage interface showing a star information bubble according to an embodiment of the invention.

FIG. 8 illustrates an exemplary webpage interface showing a star information bubble according to an embodiment of the invention.

FIG. 9 illustrates an exemplary webpage interface showing a webpage interface for selecting a graphic object.

FIG. 10 illustrates an exemplary webpage interface for choosing design options for designing a graphic object.

FIG. 11 illustrates an exemplary webpage interface for adding personal information to a graphic object.

FIG. 12 illustrates a design preview webpage interface.

FIG. 13 illustrates a webpage interface for selecting a location for positioning a graphic object.

FIG. 14 illustrates a webpage interface for selecting or creating a galaxy for positioning a graphic object.

FIG. 15 illustrates a webpage interface for selecting a galaxy type for positioning a graphic object.

FIG. 16 shows an exemplary flow diagram illustrating an interactive on-line fundraising promotion process according to an embodiment of the invention.

FIG. 17 illustrates a computer system that may be employed to implement one or more embodiments of the invention.

### DETAILED DESCRIPTION OF THE EXEMPLARY EMBODIMENTS

In the following description of exemplary embodiments, reference is made to the accompanying drawings which form a part hereof, and in which it is shown by way of illustration specific embodiments in which the disclosure may be practiced. It is to be understood that other embodiments may be utilized and structural changes may be made without departing from the scope of the exemplary embodiments of the invention.

The invention is described below with reference to webpages. However, persons of skill in the art would recognize that the invention may not be limited to webpages but is applicable to any visual information unit. A visual information unit is any set of information which is configured to be at least partially visually represented to a user. In addition to visual information, the visual information unit may also include audio and/or video information.

The present disclosure is directed toward systems and methods for allowing a user to design graphical objects for presentation on a webpage in exchange of a donation paid via the webpage. In accordance with one embodiment, graphical objects may be a star or a constellation. As used herein, a star is a graphical object resembling a star, and a constellation or a galaxy is a graphical object resembling several stars. It should be noted that the terms “constellation” and “galaxy” can be used interchangeably throughout the specification and the claims. Various embodiment of the invention, however, may use different types of graphical objects that may be different from stars and constellations.

Embodiments of the invention are described herein in the context of one practical application, namely, on-line donation. Through the purchase or establishment of stars and constellations on-line, donors worldwide may have the opportunity to donate to a worthy cause. Each star may include a special message from the donor, one or more website links and the possibility to add a photo or logo. Stars may be used, without limitation, as a tribute, promotional tool or means of expressing support.

Embodiments of the invention, however, are not limited to donation applications, and the methods described herein may also be utilized in other applications such as creating and purchasing advertising on-line, and the like. As would be apparent to one of ordinary skill in the art after reading this description, the invention is not limited to operating in accordance with the examples described in the specification.

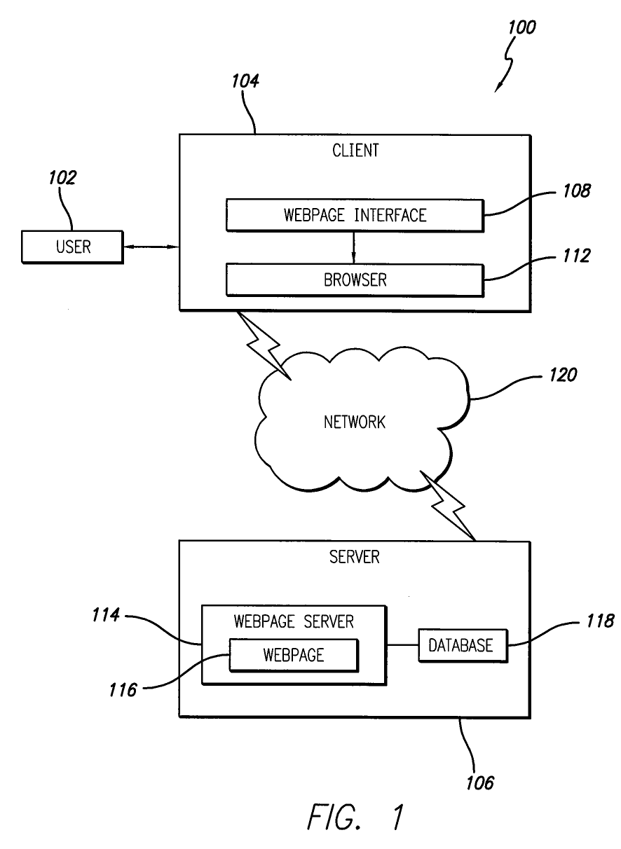

FIG. 1 is a diagram of an exemplary environment of operation according to one or more embodiments of the invention. Environment 100 comprises a client 104 which comprises: a webpage interface 108, a browser 112, and a server 106. The server comprises: a webpage server 114, a webpage 116, and a database 118. Generally, the client 104 (or a plurality of clients) may access the server 106 via network 120.

The client 104 and the server 106, according to one or more embodiments of the invention, may include any one of various types of computer devices, such as, e.g., a processing unit, a memory (including a permanent storage device), and a communication interface, as well as other conventional computer components (e.g., an input device such as a keyboard and mouse, and an output device such as a display). For example, the client 104 may include user devices such as a desktop computer, a laptop computer, a mobile device such as a mobile phone, a web-enabled phone, a smart phone, and the like.

The client 104 may communicate with the server 106 using suitable communication interfaces via the network 120, such as a wireless communication system or the Internet. The client 104 and the server 106 may communicate, in part or in whole, via wireless or hardwired communications, such as Ethernet, IEEE 802.11b wireless, or the like. Additionally, communication between the client 104 and the server 106 may include various servers such as a mail server, a webpage server, and the like.

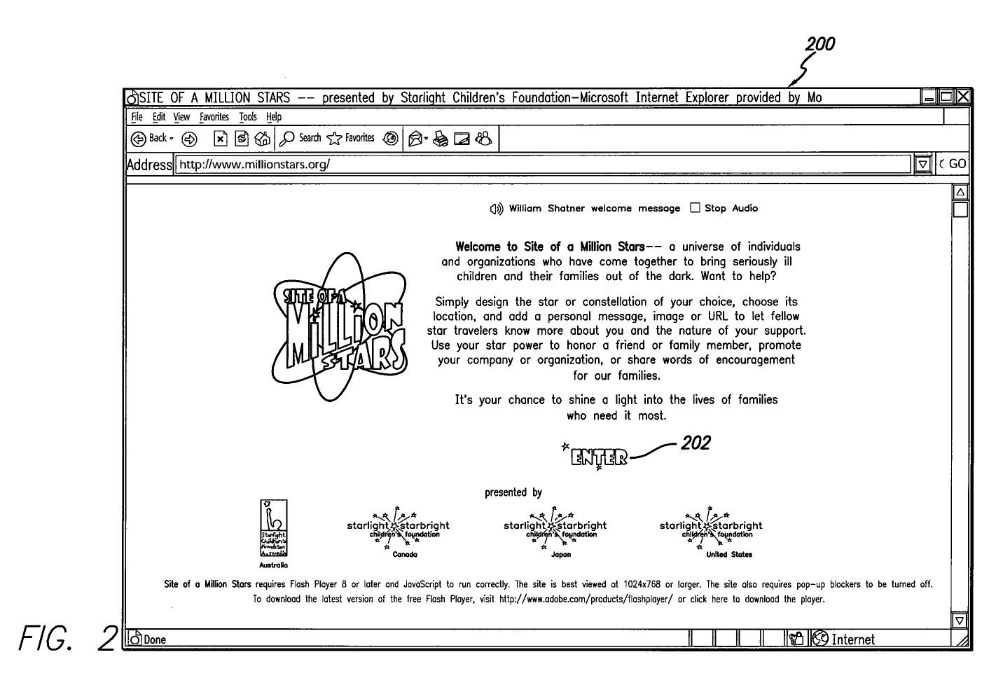

The client 104 may comprise a webpage interface 108 as explained in more detail below in the context of discussion of FIGS. 2-15. The webpage interface 108 is operable to accept user input via input devices such as a mouse, keyboard, stylus, or touch screen, and to change the content, and/or the actions of the webpage interface 108. The client 104 may further comprise a mobile device such as, a cell phone, PDA, or other devices including various types of displays. The webpage interface 108 may be a webpage or a website interface presented by a server such as, for example, a webpage server 114. The webpage interface 108 may be used by a user (end user) to utilize and operate the interactive on-line fundraising promotion environment 100.

An end user 102 may utilize the client 104 (e.g., a computer) which includes the browser 112 to view the webpage interface 108. The end user 102 is a person that views the webpage interface 108, and he/she need not have participated in the design of the webpage interface 108. The end user 102 may view and further interact with the webpage interface 108.

The browser 112 obtains some or most of the webpage 116 from the webpage server 114 through the Internet 120. The browser 112 may then display the entire webpage 116 to the user on the client 104 via the webpage interface 108.

The server 106 may be programmed to format data, accessed from local or remote databases or other sources of data, for presentation to user 102 of the client 104, for example, in the formats discussed in detail below. The server 106 may utilize various Web data interface techniques such as the Common Gateway Interface (CGI) protocol and associated applications (or “scripts”), Java™ “servlets”, e.g., Java™ applications running on the server 106, or the like to present information and receive input from the client 104. The server 106 may be implemented as, for example, a computer program, and may include a webpage server 114, e.g., Apache™ or the like. The server 106, although described herein in the singular, may actually comprise plural computers, programs, devices, backends, and the like, communicating (wired or wireless) and cooperating to perform the functions described herein.

The server 106 may be a centralized facility, or any or all of its various functions may be distributed across a plurality of facilities or locations in a geographically diverse manner. Furthermore, the various functions described herein as attributable to an interactive on-line fundraising promotion system may be distributed to and among the various facilities serviced by the server 106.

The server 106 may include a database 118 which holds the data pertaining to operation of the interactive on-line fundraising promotion technology. The data may include prices (or donation amounts) for various designs, colors, sizes, effects, graphical objects, and the like. Furthermore, the server 106 may store customized designs from the end user 102 such as selected graphic objects, logos, text messages, photographs, video data, audio data, and the like. The data may also include the end user 102 profile such as, without limitation, end user names, end user addresses, payment information, and the like.

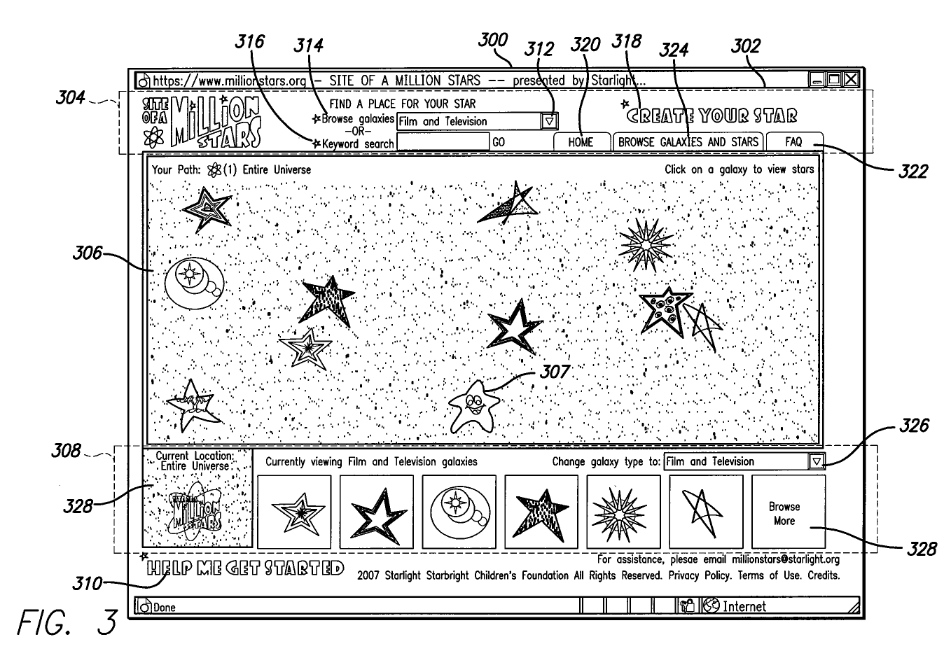

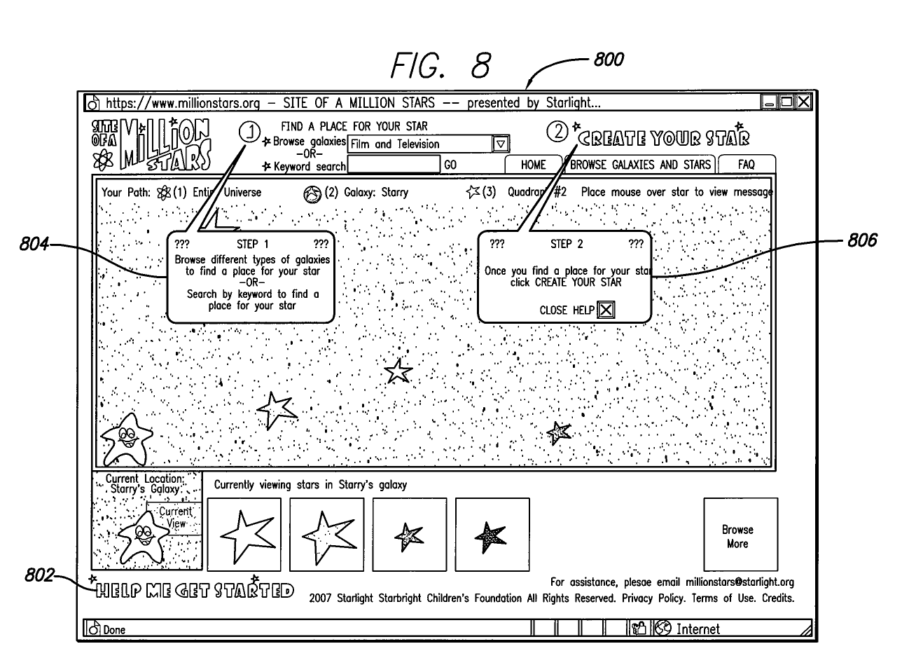

FIGS. 2-15 are illustrations of webpage interfaces 200-1500 according to one or more embodiments of the invention. FIGS. 3-7 illustrate how a user can explore galaxies and stars using webpage interfaces 300-700. FIGS. 8-15 illustrate how a user can design and create graphical objects using webpage interfaces 800-1500 in exchange for on-line payment or donation. The user (donor) can design stars and constellations (preferably multi-colored) on-line, and add to them personal messages, website links, photos, logos and the like.

FIG. 2 is an illustration of an exemplary on-line interactive promotional fundraising webpage interface 200 according to an embodiment of the invention. The webpage interface 200 is generated using one or more computers, servers, workstations, or other data gathering, processing, computing and reporting systems. For example, server 106 may provide the data storage, record keeping and retrieval capabilities for the interface 200 as explained below, and may include one or more databases to store the various data and other information used in the on-line interactive promotional fundraising environment 100. Data storage may be across any physical or logical data storage architecture, and any of a number of database models may be implemented. In one embodiment, a relational database structure is used to facilitate creation of responses from various separate sources of data.

The interface 200 comprises an “Enter” button 202. Activating or clicking on the “Enter” button 202 opens a webpage interface 300 showing a depiction of an entire universe in which a user can explore galaxies and/or proceed to design a star or a constellation as explained below.

FIG. 3 illustrates the webpage interface 300 showing the depiction of a part of the universe which includes galaxies of a particular type (e.g., “film and television” galaxies). The webpage interface 300 includes: a header area 302, an entire universe viewing area 306, a first selection area 304, a second selection area 308, and a “Help me get started” button 310.

The header area 302 identifies the service provider (e.g., Site of a Million Stars™). It may also include an explanation of services.

The entire universe viewing area 306 allows the user to view the galaxies available in the entire universe 306 (or a portion thereof). Each galaxy is from a particular category, such as, without limitation, celebrations, community, film and television, music, schools, sports, starlight children and families, and the like. Because of a relatively high number of galaxies, in some embodiments the entire universe view may only show galaxies from a particular category (such as, for example, “film and television”). The type of galaxies currently being shown can be selected by using menu 326.

The first selection area 304 allows the user to find a location for her/his graphic object (e.g., a star). The first selection area may include: a browse galaxies area 314, a keyword search area 316, a “Create your star” button 318, a “Home” button 320, a frequently asked questions “FAQ” button 322, and a “Browse galaxy and stars” button 324.

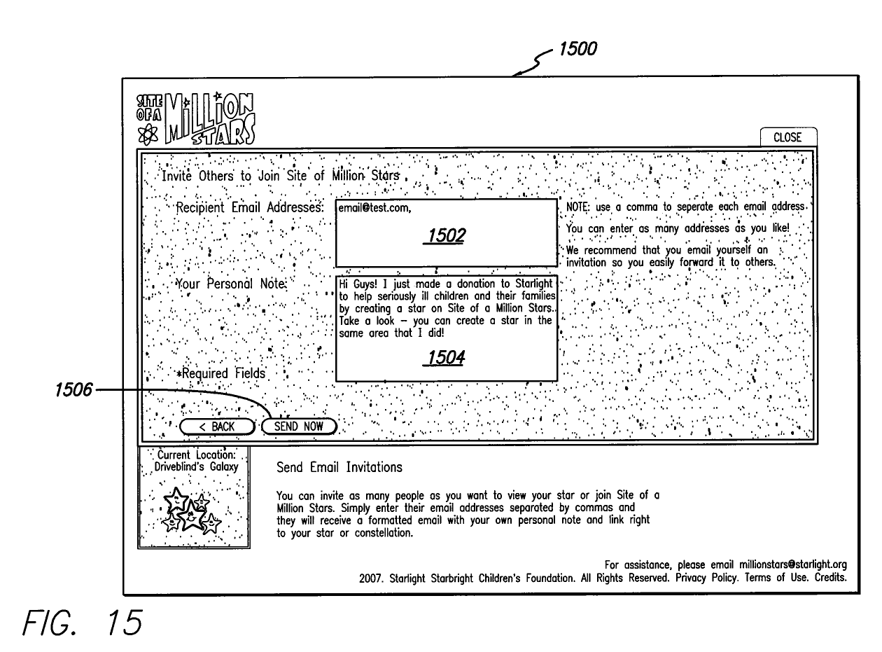

In one embodiment, the user may choose to explore the galaxies (i.e., instead-of, or before designing a star). In this manner, the user can click or activate the button 312 to view a list (e.g., a drop-down menu) of available types of galaxies in the browse galaxies area 314, and the user may select a type of galaxies from this list. The list of the available types of galaxies may include the categories of galaxies as explained above. The user may also search for a galaxy of her/his interest by typing the name of the corresponding category in the search field 316. For example, the user may type “film and television” in the search area 316. Alternatively, the user may activate the “Browse galaxy and stars” button 324 to choose a galaxy as explained in more detail in the context of discussion of FIG. 14. Clicking-on or activation-of the “Create your star” button 318 allows the user to design her/his own star as explained in more detail below. Activating the “Home” button 320 allows the user to return to the entire universe viewing area 306. Activation of the “FAQ” button 322 allows the user to view the information related to the website and the website provider.

The second selection area 308 shows another view of the currently viewing galaxies (e.g., “film and television” galaxies). The user can use the “Browse” button 328 to view more galaxies in the currently viewed galaxies, or change the galaxy type. In this manner, the user may click on or activate the button 326 to view a list of the available galaxies in a drop-down menu as explained above. The user may then choose a galaxy type (category) from this list by clicking on or activating the galaxy type.

A “Help me get started” button 310 can be activated by the user to provide help for the user to create his/her star as explained below.

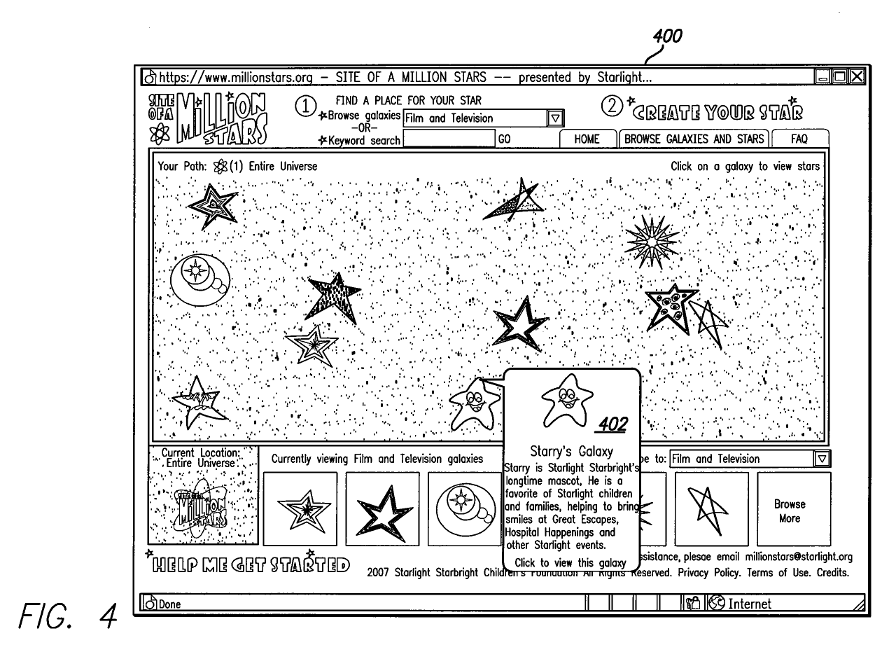

The user can further explore the universe by moving a cursor onto any of the galaxies shown in the entire universe area 306. For example, the user may move the cursor onto the galaxy 307 to view more information about the galaxy 307 as shown in FIG. 4 below.

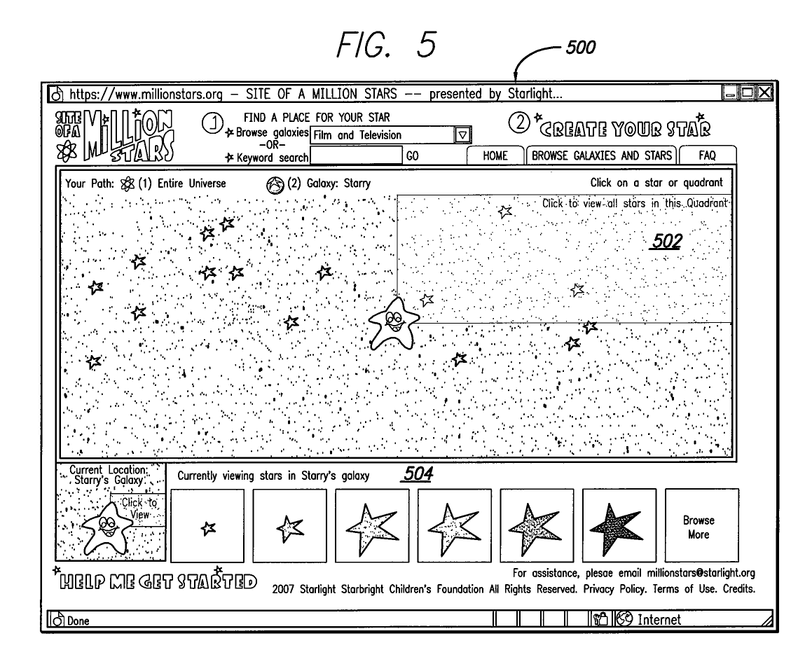

Moving the cursor onto the galaxy 307 (FIG. 3) displays a bubble (galaxy information bubble) 402 (FIG. 4) on the entire universe viewing area 306 (FIG. 3). For example, the bubble 402 may show the name of the galaxy 307 (“Starry's galaxy”) and information about Starry's galaxy. The user can click on or activate the bubble 402 to view the stars in the Starry's galaxy as shown in FIG. 5.

FIG. 5 shows the stars in the Starry's galaxy. Generally, each galaxy includes four quadrants. The user can choose from any of the four quadrants in any of the galaxies by moving the cursor on a particular quadrant. For example, as shown in FIG. 5, the user can move the cursor onto the quadrant 502 (one of the quadrants in the Starry's galaxy) to view the star in the quadrant 502. The user can then activate or click on the quadrant 502 to view the stars available in the quadrant 502. The user can alternatively, view the currently viewing stars and the current location of Starry's galaxy in the viewing area 504.

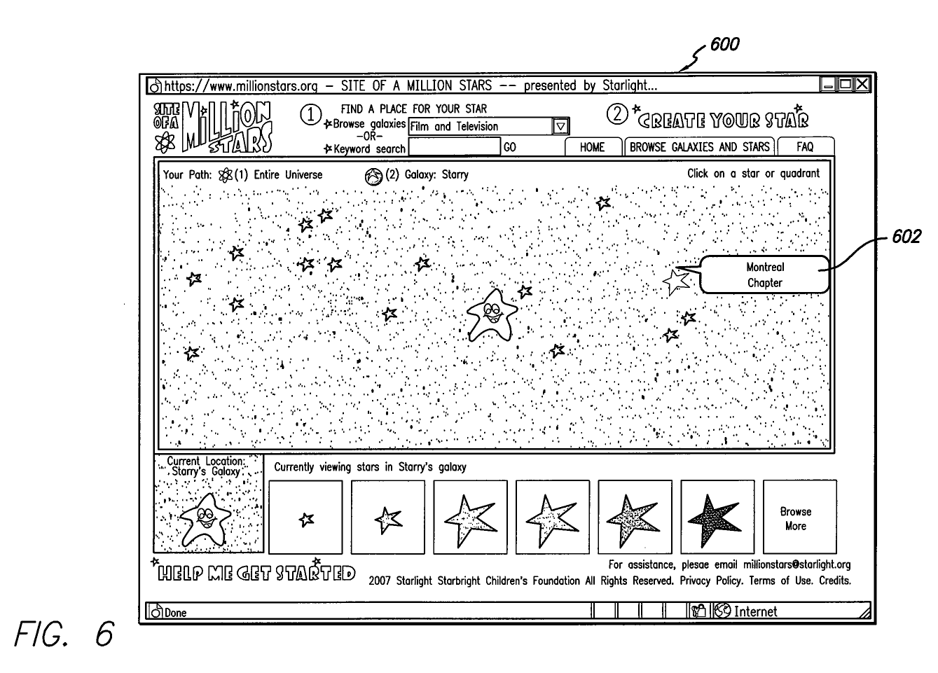

By activating or clicking on the quadrant 502 (FIG. 5), the user can view the stars in the Starry's galaxy quadrant 502 as shown in FIG. 6. Additionally, the user can move the cursor on a star on the quadrant 502 to view the name of that star. For example, the user can move the cursor on the Montreal-chapter star to view a bubble (star information bubble) 602 containing the name of this star.

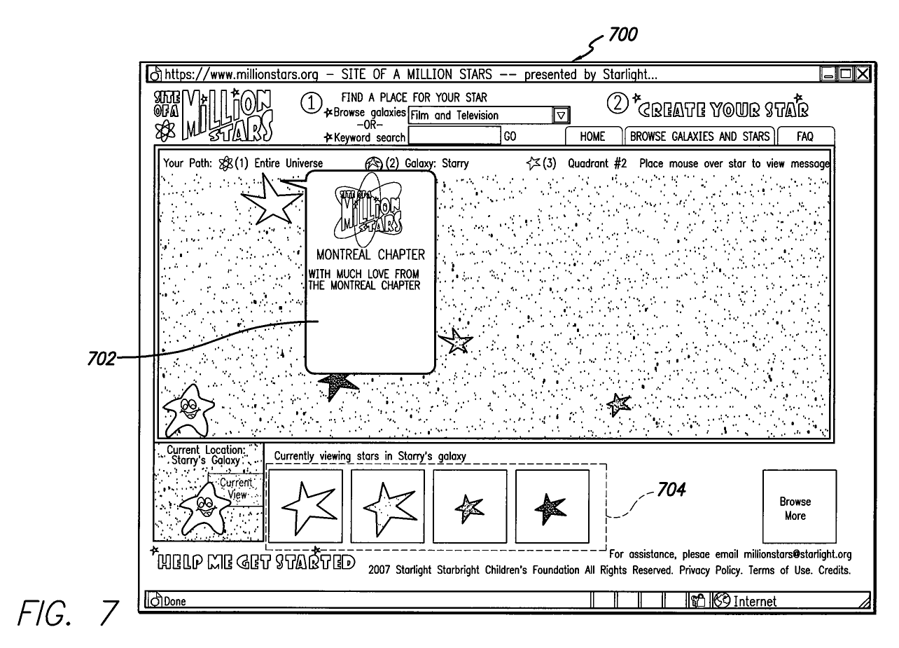

Personalized information (“with much love from the Montreal Chapter”) about this star may be displayed on the bubble 702, on the webpage interface 700 (FIG. 7), by activating the bubble 602 (FIG. 6). Furthermore, the user can view the stars in the quadrant 502 (FIG. 5) of the Starr's galaxy in the currently viewing stars area 704.

As explained above, in one embodiment, users can design their own graphic objects such as stars or galaxies in exchange for a donation on-line. For example, a galaxy can represent a company, and the star can represent its employee. Each employee can contribute to a certain cause, and in exchange design their own star with their own preferences (e.g., color, size, message, effect, photo, and the like) for presentation on the webpage interface 108.

Through the purchase of multi-colored stars and constellations on-line, donors worldwide may have the opportunity to contribute to an important cause. Each star may include a special message from the donor, a website link or links, and the possibility to add a photo or logo. Stars may be used as a tribute, promotional tools or means of expressing support.

As shown in FIG. 8, by activating or clicking on the Starry's galaxy “Create your star” button 318 (FIG. 3), users can start design their own star. The users can also activate or click on the “Help me get started” button 802 to get message bubbles 804 and 806 for obtaining more information regarding the design steps. In one embodiment, a user can first design a star and find a location for her/his star. In another embodiment, a user can first find a location and then design a star.

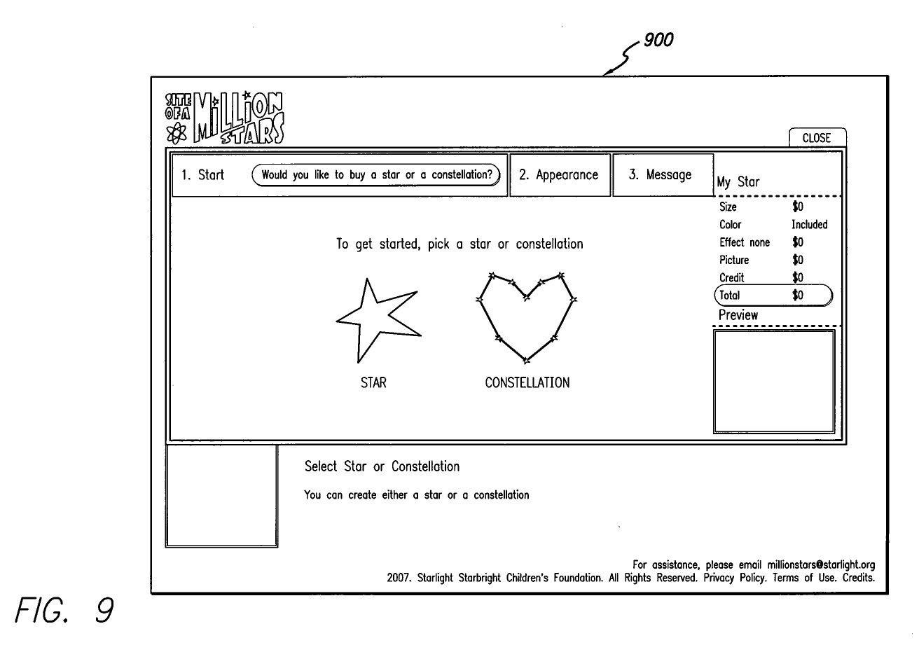

Activating or clicking on “Create your star” button 318 opens webpage interface 900. The webpage interface 900 allows the user to choose a star or a constellation (a type of a graphic object) by clicking on or activating the star or the constellation. The star and the constellation are shown on the interactive graphic on the webpage interface 900 of FIG. 9.

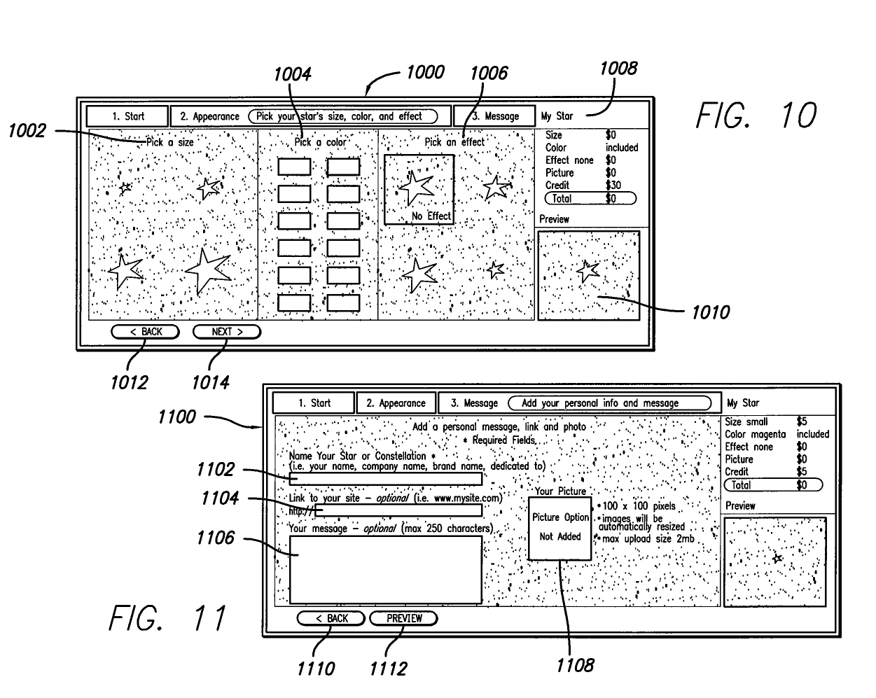

Having selected a graphic object such as a star or a constellation, the user can then select design options for the appearance of the graphic object. The design options for designing the appearance of the graphic object are provided to the user on the webpage interface 1000 (FIG. 10). The user can select a size 1002, a color 1004 (e.g., red, blue, white, etc.), and an effect 1006 (e.g., twinkling, spinning, and the like). The user can then view a total donation amount 1008 associated with her/his design, and a preview of the design 1010. The user can also go back to the webpage 900 for changing the graphic object by clicking-on or by activation-of the “Back” button 1012. The user can click or activate the “Next” button 1014 to proceed adding her/his personal information and messages.

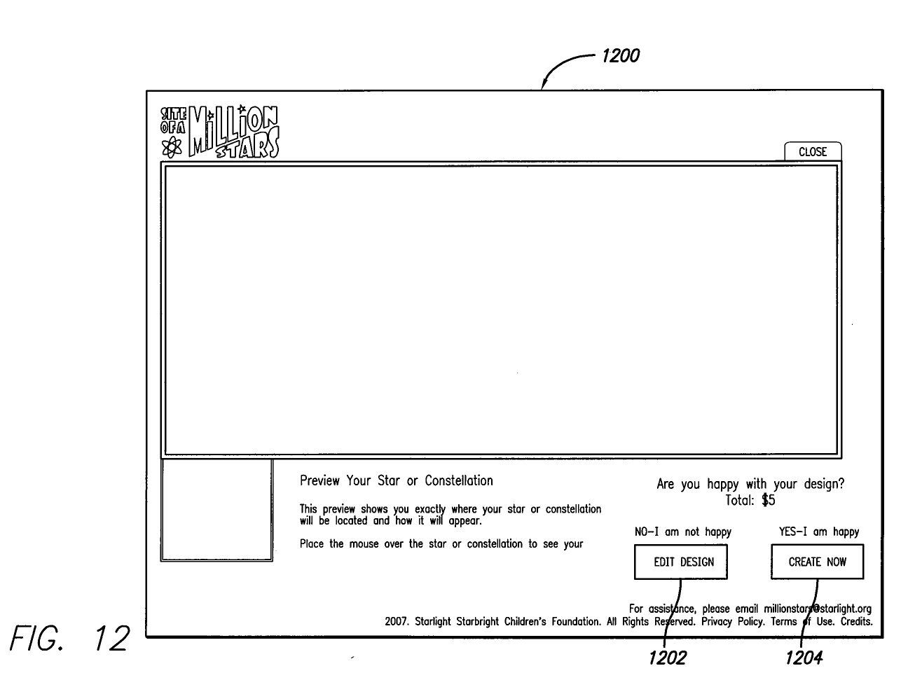

FIG. 11 shows an interface 1100 for further customizing the star by allowing the user to add his/her personal information and messages. For example, the user can choose to name the star 1102 with her/his name, a company name, a brand name, and the like. The user can also add a link to her/his website (e.g., mywebsite.com) 1104, add a message 1106, and a photo 1108. The user can activate the “Back” button 1110 to go back to the webpage 1000 and redesign the graphic object, or he/she can preview the design by activating the button 1112 and opening the webpage interface 1200.

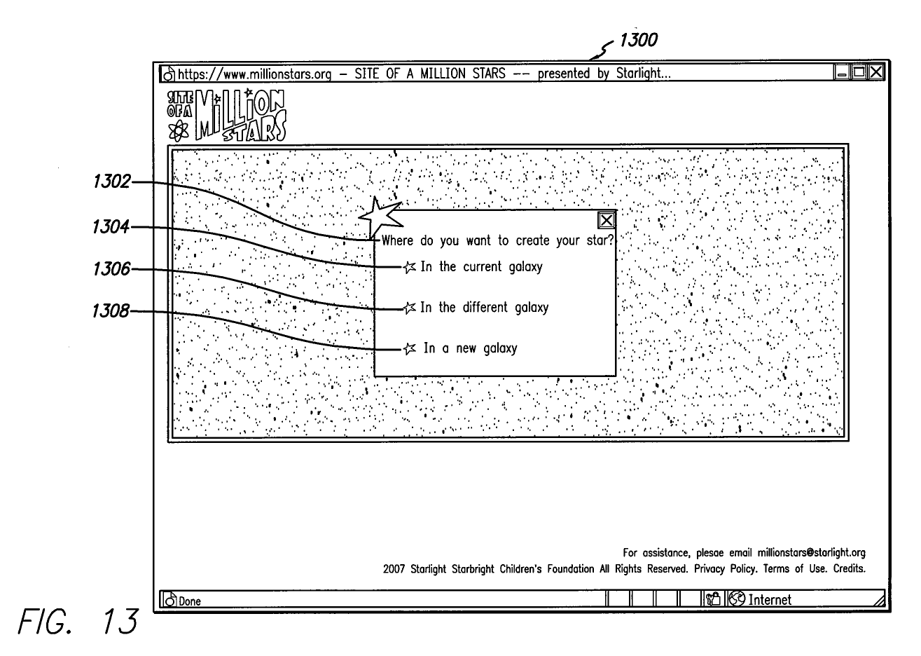

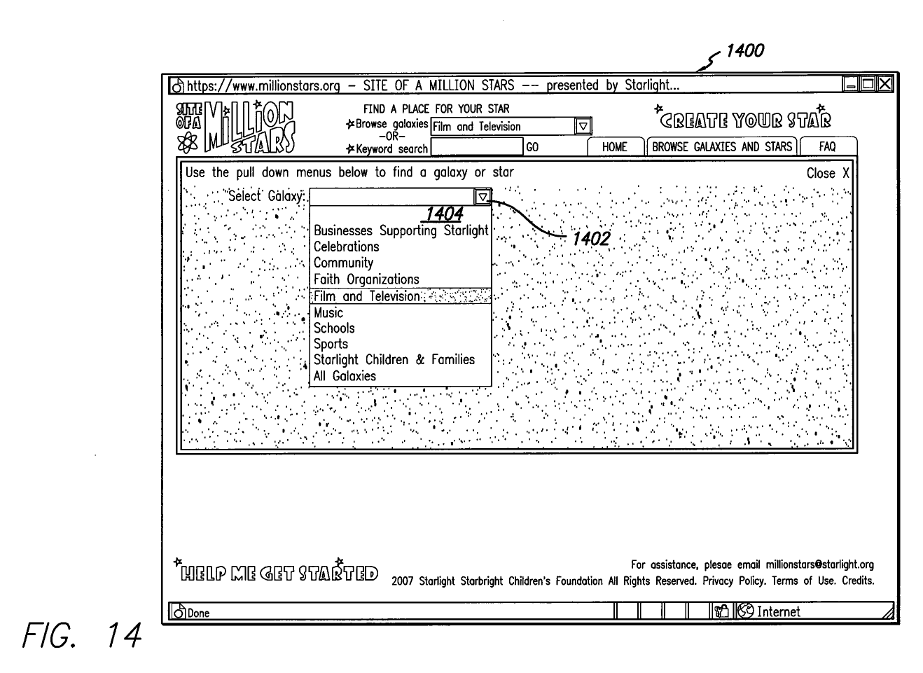

FIG. 12 shows the design preview webpage interface 1200. The user can edit the design using the “Edit design” button 1202 or create the design using the “Create now” button 1204. If the user activates the “Create now” button 1204, then a webpage interface 1300 (FIG. 13) opens allowing the user to select a location 1302 for her/his star. The user can create her/his star in an inherited galaxy, in a different galaxy, or in a new galaxy. The inherited galaxy is a galaxy that the user selected during exploring the galaxies as explained above (e.g., Starry's galaxy in FIG. 3). The user can create her/his star in the current galaxy, by clicking on a “current galaxy” link 1304, choose another galaxy by clicking on a “different galaxy” link 1306, or choose a new galaxy by activating a “new galaxy” link 1308.

For example, by activating the “different galaxy” link 1306 a webpage interface 1400 (FIG. 14) may be opened. The webpage interface 1400 allows the user to activate the drop-down menu 1404 by clicking on the button 1402. The user can then select from an exemplary list of available galaxies shown on the drop-down menu 1402. Alternatively, a user can use a search field (not shown in FIG. 14) to search for a galaxy location.

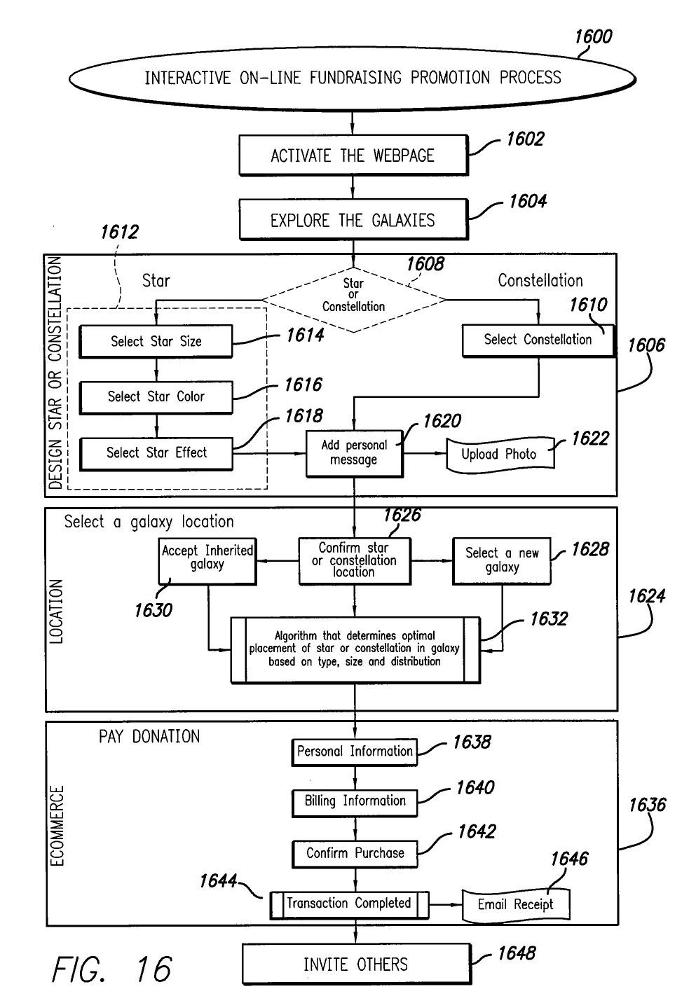

Once the user selects a location for her/his star then he/she can proceed to complete a user profile and pay a donation using a payment webpage (not shown). The user can then invite others to view his/her star via email as shown in FIG. 15. The user can invite others to join the website using a webpage interface 1500. The user can indicate the email of the recipient 1502, write a message for the recipient 1504, and send the email using the “Send now” button 1506.

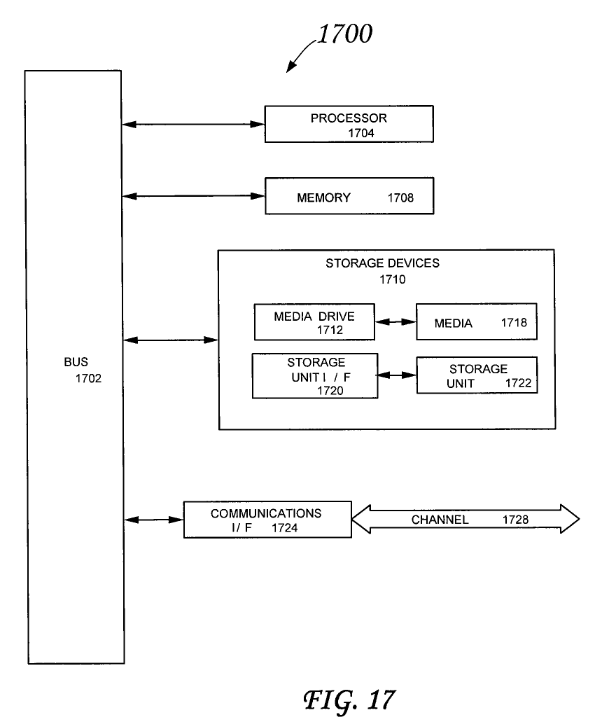

FIG. 16 shows an exemplary flow diagram illustrating an interactive on-line fundraising promotion process 1600 according to an embodiment of the invention. The various tasks performed in connection with process 1600 may be performed by software, hardware, firmware, a computer-readable medium having computer executable instructions for performing the process method, or any combination thereof. It should be appreciated that process 1600 may include any number of additional or alternative tasks, the tasks shown in FIG. 16 need not be performed in the illustrated order, and process 1600 may be incorporated into a more comprehensive procedure or process having additional functionality not described in detail herein. For illustrative purposes, the following description of process 1600 may refer to elements mentioned above in connection with FIGS. 2-15. In various embodiments, portions of process 1600 may be performed by different elements of environment 1600, e.g., the client, server, and user interface.

Process 1600 allows the user to purchase multi-colored stars and constellations on-line. In this manner, donors worldwide may have the opportunity to contribute to an important cause (such as raising money for seriously ill children). Each star can include a special message from the donor, website link and the possibility to add a photo or logo. Stars can be used as a tribute, promotional tool or means of expressing support.

Process 1600 may begin by the user activating the webpage interface 108 via the browser 112 (task 1602). The user may then explore the galaxy as explained above in the context of discussion of FIGS. 3-7. Or, the user may begin designing a graphic object (task block 1606) such as a star or a constellation (FIG. 9). If the user selects a constellation (constellation branch of the inquiry task 1608), the user may proceed to add her/his personal preferences (FIG. 11) such as a text message (task 1620), a photo (task 1622), video data, audio data, or the like. In this manner, each user (donor) may customize text that appears when rolling over his or her star on the webpage interface 108. The user may also add a hyperlink to a profile page or live website.

For example, a galaxy may represent a company, and each star in the galaxy may represent an employee of that company. In one embodiment, the process 1600 can provide promotional codes to customers or employees with purchase of a signature product. In one embodiment, the process may allow placing hidden prizes in the interactive graphic (e.g., universe) and awarding a prize to donors who pick the coordinates matching the prize location.

In one embodiment, if the user selects a star (star branch of the inquiry task 1608), then he/she can select from the design options 1612 (FIG. 10). The user may choose a size 1614, a color 1616, and an effect 1618 for his/her star. The user may then choose to continue to add his/her personal preferences (FIG. 11). In this manner, this custom profile/messaging capability allows the webpage interface 108 to appeal to families, philanthropic-minded businesses, donors at all levels, and other donors. Proceeds may be used to benefit programs that help seriously ill children and their families.

In one embodiment, the donations may be determined based on the user's design choices. For example, stars can require a predetermined amount of donation such as a $5 donation. In an alternative embodiment, a standard star may require no donation amount. For an additional cost (e.g., up to about $30), donors may choose to make their stars larger or add “behaviors” such as twinkling, spinning, and the like (FIG. 10). Standard constellations may cost about $100, for example. Customized constellations may also be designed per the donor's specifications for an additional amount (e.g., about $3000).

Once the user designs her/his star then the user may proceed to select a galaxy location (task block) 1624 for his/her star or constellation. The user may confirm the location of the star or constellation 1626 by accepting the inherited/current location of the galaxy (task 1630), or selecting a new galaxy (task 1628) for her/his star, as explained above in the context of FIGS. 13-14.

Once the user confirms the location of the star or constellation, the webpage server 114 may receive location information from the user, and may determine an optimal placement of the star or constellation in the galaxy based upon type, size and distribution (task 1634). In this manner, a new star or constellation may be positioned in proximity to a location specified by the location information. Alternatively, the graphic object may be assigned to one of many (e.g., about 50) predefined locations in a galaxy based on availability and type. The webpage server 114 may then evaluate the size of neighboring objects for a potential conflict due to a size and/or position of the graphic object. The webpage server 114 then automatically adjusts the position of the proposed graphic object for presentation on the webpage interface 108. The webpage server 114 continues the adjustment process until a suitable position for the graphic object is selected. For example, the suitable position may be a position near the location specified by the location information that does not overlap other stars or constellations.

Process 1600 then allows the user to pay a donation (block 1636). In order to pay the donation, the user enters his/her personal information (task 1638), and billing information (task 1640). He/she confirms the purchase (task 1642), and completes the transaction using the webpage interface 108 (task 1644). The user may also receive an email receipt (task 1646).

In one embodiment, the process 1600 further allows each donor to use a “spread the word” email tool to invite (task 1648) his or her friends and family to join the universe on the interactive graphic (FIG. 15). Donors can receive an embedded tag that can be used to place a Flash ad/link to their star location on an Internet community webpage such as a MySpace page. MySpace users may, in essence, be displaying a virtual “yellow bracelet” on their page, showcasing the philanthropic power of the MySpace community. In this manner, celebrities/bands can contribute hand-drawn stars to the universe to create their own galaxies, and invite fans to join them. The process 1600 may also publicize the site via Internet news services and communities such blogs, eNews, and the like.

Embodiments of the invention allow sponsor benefits from association with first-of-its-kind online charity promotion. They can reach people nationwide and potentially globally. Ease of participation on the website allows significant media participation potential. Furthermore, embodiments of the invention provide ways for driving traffic back to the sponsor and thereby reinforce the sponsor's brand. The sponsor's brand may also be reinforced by allowing the sponsor to customize a constellation to match their logo, thereby identifying them.

FIG. 17 illustrates a typical computing system 1700 that may be employed to implement processing functionality in embodiments of the invention. For example, computing system 1700 of this type may be used in clients and servers. Those skilled in the relevant art will also recognize how to implement the invention using other computer systems or architectures. Computing system 1700 may represent, for example, a desktop, laptop or notebook computer, hand-held computing device (PDA, cell phone, palmtop, and the like), mainframe, server, client, or any other type of special or general purpose computing device as may be desirable or appropriate for a given application or environment. Computing system 1700 can include one or more processors, such as a processor 1704. Processor 1704 can be implemented using a general or special purpose processing engine such as, for example, a microprocessor, microcontroller or other control logic. In this example, processor 1704 is connected to a bus 1702 or other communication medium.

Computing system 1700 can also include a main memory 1708, such as random access memory (RAM) or other dynamic memory, for storing information and instructions to be executed by processor 1704. Main memory 1708 also may be used for storing temporary variables or other intermediate information during execution of instructions to be executed by processor 1704. Computing system 1700 may likewise include a read only memory (“ROM”) or other static storage device coupled to bus 1702 for storing static information and instructions for processor 1704.

The computing system 1700 may also include information storage system 1710, which may include, for example, a media drive 1712 and a removable storage interface 1720. The media drive 1712 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1718 may include, for example, a hard disk, floppy disk, magnetic tape, optical disk, CD or DVD, or other fixed or removable medium that is read by and written to by media drive 1712. As these examples illustrate, the storage media 1718 may include a computer-readable storage medium having stored therein particular computer software or data.

In alternative embodiments, information storage devices 1710 may include other similar components for allowing computer programs or other instructions or data to be loaded into computing system 1700. Such components may include, for example, a removable storage unit 1722 and a storage unit interface 1720, such as a program cartridge and cartridge interface, a removable memory (for example, a flash memory or other removable memory module) and memory slot, and other removable storage units 1722 and interfaces 1720 that allow software and data to be transferred from the removable storage unit 1718 to computing system 1700.

Computing system 1700 can also include a communications interface 1724. Communications interface 1724 can be used to allow software and data to be transferred between computing system 1700 and external devices. Examples of communications interface 1724 can include a modem, a network interface (such as an Ethernet or other NIC card), a communications port (such as for example, a USB port), a PCMCIA slot and card, and the like. Software and data transferred via communications interface 1724 are in the form of signals which can be electronic, electromagnetic, optical, or other signals capable of being received by communications interface 1724. These signals are provided to communications interface 1724 via a channel 1728. This channel 1728 may carry signals and may be implemented using a wireless medium, wire or cable, fiber optics, or other communications medium. Some examples of a channel include a phone line, a cellular phone link, an RF link, a network interface, a local or wide area network, and other communications channels 1728 to perform features or functions of embodiments of the invention. Note that the code may directly cause the processor to perform specified operations, be compiled to do so, and/or be combined with other software, hardware, and/or firmware elements (e.g., libraries for performing standard functions) to do so.

While various embodiments of the invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skilled in the art, two or more modules may be combined to form a single module that performs the associated functions according embodiments of the invention.

In this document, the terms “computer program product”, “computer-readable medium”, and the like may be used generally to refer to media such as, for example, memory 1708, storage devices 1710, or storage unit 1722. These and other forms of computer-readable media may be involved in storing one or more instructions for use by processor 1704 to cause the processor 1704 to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements or controllers may be performed by the same processing logic element or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A system for on-line interactive graphic design, the system comprising logic for:
providing an interactive graphic suitable for presentation on a webpage interface;
providing a plurality of design options to a user of the interactive graphic;
allowing the user to design a graphic object for presentation as a part of the interactive graphic, wherein the graphic object is based in part on at least one of the design options;
receiving location information from the user, wherein the location information specifies a location for the graphic object on the interactive graphic; and
receiving a donation from the user based in part on the at least one of the design options.

2. The system of claim 1, further comprising logic for providing the graphic object for display as a part of the interactive graphic, wherein the graphic object is located on the interactive graphic in proximity to the location specified by the location information.

3. The system of claim 1, further comprising logic for determining the location for the graphic object based upon at least one of the group consisting of: type of the graphic object, and size of the graphic object.

4. The system of claim 1, further comprising logic for allowing the user to select a location from a plurality of possible locations, wherein the plurality of possible locations is based on relationships between the user and other users and organizations.

5. The system of claim 1, wherein the allowing step further comprises logic for:
receiving a selection of the graphic object; and
receiving the at least one of the design options from the user.

6. The system of claim 1, wherein the graphic object comprises at least one of the group consisting of: a star and a constellation.

7. The system of claim 1, wherein the design options comprise at least one of the group consisting of: a color, a size, an effect, a photo, a video, and a text message.

8. The system of claim 7, wherein the effect comprises at least one of the group consisting of: twinkling and spinning.

9. The system of claim 1, further comprising a database for storing data pertaining to at least one of the group consisting of: the location information, the design options, donation amounts, a user profile, a customized design, and the graphic object.

10. The system of claim 1, wherein the location information comprises a location of a galaxy of the interactive graphic.

11. The system of claim 1, wherein the interactive graphic comprises a depiction of a universe.

12. The system of claim 11, wherein the universe comprises galaxies.

13. The system of claim 12, wherein the galaxies comprise stars and constellations.

14. The system of claim 13, wherein the graphical object comprises a star or a constellation, and the location information comprises a galaxy of which the star or constellation is a part of.

15. The system of claim 11, further comprising logic for allowing a user to create a new galaxy.

16. The system of claim 1, further comprising logic for inviting another user to visit the webpage interface.

17. The system of claim 1, further comprising a server operable to send the interactive graphic to the webpage interface in response to a request from a browser.

18. The system of claim 1, wherein the webpage interface is operable to interact with the user.

19. The system of claim 1, further comprising logic for placing hidden prizes on a prize location on the interactive graphic.

20. The system of claim 19, further comprising logic for rewarding donors who pick coordinates matching the prize location.

21. A method for on-line interactive graphic design, the method comprising the steps of:
allowing a user to design a graphic object for presentation as a part of an interactive graphic, wherein the interactive graphic is suitable for presentation on a webpage interface;
receiving location information from a user, wherein the location information specifies a location for the graphic object on the interactive graphic; and
receiving a donation from the user based on a design of the graphic object.

22. The method of claim 21, further comprising a step of providing the graphic object for display as a part of the interactive graphic, wherein the graphic object is located on the interactive graphic in proximity to the location specified by the location information.

23. The method of claim 21, further comprising a step of determining the location for the graphic object based upon at least one of the group consisting of: type of the graphic object, and size of the graphic object.

24. The method of claim 21, further comprising a step of allowing the user to select a location from a plurality of possible locations, wherein the plurality of possible locations is based on relationships between the user and other users and organizations.

25. The method of claim 21, further comprising a step of providing a plurality of design options to a user of the interactive graphic.

26. The method of claim 25, wherein the design options comprise at least one of the group consisting of: a color, a size, an effect, a photo, a video, and a text message.

27. The method of claim 26, wherein the effect comprises at least one of the group consisting of: twinkling and spinning.

28. The method of claim 25, further comprising a step of storing data pertaining to at least one of the group consisting of: the location information, the design options, donation amounts, a user profile, a customized design, and the graphic object.

29. The method of claim 25, further comprising a step of receiving the donation from the user based in part on at least one of the design options.

30. The method of claim 25, further comprising the steps of:
receiving a selection of the graphic object from the user; and
receiving the at least one of the design options from the user.

31. The method of claim 21, wherein the graphic object comprises at least one of the group consisting of: a star and a constellation.

32. The method of claim 21, wherein the interactive graphic comprises depiction of a universe.

33. The method of claim 32, wherein the universe comprises galaxies.

34. The method of claim 33, wherein the galaxies comprise stars and constellations.

35. The method of claim 34, wherein the graphical object comprises a star or a constellation, and the location information comprises a galaxy of which the star or constellation is a part of.

36. The method of claim 21, further comprising a step of allowing a user to create a new galaxy.

37. The method of claim 21, wherein the location comprises an inherited location.

38. The method of claim 21, wherein the location comprises a new location.

39. The method of claim 21, wherein the location information comprises location of a galaxy on the interactive graphic.

40. The method of claim 21, further comprising a step of inviting another user to visit the webpage interface.

41. The method of claim 21, further comprising a step of sending the interactive graphic to the webpage interface in response to a request from a browser.

42. The method of claim 21, wherein the method is executed by a server operable to provide the interactive graphic for display on the webpage interface in response to a request from a browser.

43. The method of claim 21, further comprising a step of placing hidden prizes at a prize location on the interactive graphic.

44. The method of claim 43, further comprising a step of rewarding donors who pick coordinates matching the prize location.

45. A computer-readable medium comprising program code for providing an on-line interactive graphic design, the program code for causing a computer to perform the steps of:
allowing a user to design a graphic object for presentation as a part of an interactive graphic, wherein the interactive graphic is suitable for presentation on a webpage interface;
receiving location information from a user, wherein the location information is associated with a location on the interactive graphic; and
receiving a donation from the user based on a design of the graphic object.

46. The computer-readable medium of claim 45, further comprising program code for causing the computer to perform a step of providing the graphic object for display as a part of the interactive graphic, wherein the graphic object is located on the interactive graphic in proximity to the location specified by the location information.

47. The computer-readable medium of claim 45, further comprising program code for causing the computer to perform a step of determining the location for the graphic object based upon at least one of the group consisting of: type of the graphic object, and size of the graphic object.

48. The computer-readable medium of claim 45, further comprising program code for causing the computer to perform a step of allowing the user to select a location from a plurality of possible locations, wherein the plurality of possible locations is based on relationships between the user and other users and organizations.

49. The computer-readable medium of claim 49, further comprising program code for causing the computer to perform a step of providing a plurality of design options to a user on the interactive graphic.

50. The computer-readable medium of claim 49, wherein the design options comprise at least one of the group consisting of: a color, a size, an effect, a photo, a video, and a text message.

51. The computer-readable medium of claim 49, further comprising program code for causing the computer to perform the steps of:
receiving a selection of the graphic object from the user; and
receiving the at least one of the design options from the user.

52. The computer-readable medium of claim 49, further comprising program code for causing the computer to perform a step of storing data pertaining to at least one of the group consisting of: the location information, the design options, donation amounts, a user profile, a customized design, and the graphic object.

53. The computer-readable medium of claim 49, further comprising program code for causing the computer to perform a step of receiving the donation from the user based in part on at least one of the design options.

54. The computer-readable medium of claim 45, wherein the graphic object comprises at least one of the group consisting of: a star, and a constellation.

55. The computer-readable of claim 45, wherein the interactive graphic comprises depiction of a universe.

56. The computer-readable medium of claim 55, wherein the universe comprises galaxies.

57. The computer-readable medium of claim 56, wherein the galaxies comprise stars and constellations.

58. The computer-readable medium of claim 57, wherein the graphical object comprises a star or a constellation, and the location information comprises a galaxy of which the star or constellation is a part of.

59. The computer-readable medium of claim 55, further comprising program code for causing the computer to perform a step of allowing a user to create a new galaxy.

60. The computer-readable medium of claim 45, wherein the location information comprises location of galaxy on the interactive graphic.

61. The computer-readable medium of claim 45, further comprising program code for causing the computer to perform a step of inviting another user to visit the webpage interface.

62. The computer-readable medium of claim 45, further comprising program code for causing the computer to perform a step of placing a hidden prize on a prize location on the interactive graphic.

63. The computer-readable medium of claim 62, further comprising program code for causing the computer to perform a step of rewarding donors who pick coordinates on the interactive graphic matching the prize location.

64. The computer-readable medium of claim 45, further comprising program code for causing the computer to perform a step of sending the interactive graphic to a client's device in response to a request from a client's device browser.

65. A method for on-line fundraising using the Internet, the method comprising the steps of:
receiving a donation from a user; and
allowing a user to select an impregnable object for presentation as a part of an interactive graphic, wherein the interactive graphic is presented on a webpage interface.

66. The method of claim 1, further comprising a step of providing the impregnable object for display as a part of the interactive graphic.

67. The method of claim 1, further comprising a step of storing data pertaining to at least one of the group consisting of: donation amounts, a user profile, and the impregnable object.

68. The method of claim 1, further comprising a step of receiving a selection of the impregnable graphic object from the user.

69. The method of claim 1, wherein the impregnable object comprises one of a star, a constellation, and a galaxy.

70. The method of claim 1, further comprising a step of, in response to a user command, searching for a particular star, constellation, or galaxy.

71. The method of claim 1, further comprising a step of allowing a user to add a personalized text message on the impregnable object.

72. The method of claim 1, further comprising a step of sending the interactive graphic to the webpage interface in response to a request from a browser.
